(19) United States
(12) Patent Application Publication
(10) Pub. No.: US 2005/0181875 A1
(43) Pub. Date: Aug. 18, 2005

(54) Mobile lottery, gaming and wagering system and method

(75) Inventors: George Hoehne, St Charles, IL (US); Martin Peek, Hoffman Estates, IL (US); Richard Currie, Naperville, IL (US)

Correspondence Address: SCHIFF HARDIN, LLP;PATENT DEPARTMENT, 6600 SEARS TOWER, CHICAGO, IL, 60606-6473, US

(73) Assignee: Coin Mechanisms, Inc.

(21) Appl. No.: 10/781,114

(22) Filed: Feb. 18, 2004

(51) Int. Cl. G06F 19/00; H04M 11/00

(52) U.S. Cl. 463/41

(57) ABSTRACT

An apparatus or method to allow the secure downloading of an operating system, file management system and or state machine to a Miniature Smart Card (MSC) such as a Subscriber Identity Module (SIM), Universal Subscriber Identity Module (USIM), Removable User Identity Module (RUIM) or Universal Integrated Chip Card (UICC) in a mobile appliance (MA), such as but not limited to a mobile phone, personal digital assistant (PDA), pager or a proprietary device. This would in turn allow an E-purse applet as well as Lottery, Wagering and Gaming applets to be downloaded to the same Miniature Smart Card (MSC) and further allow the downloading of e-cash to be used to remotely play the Lottery, Wagering or Gaming applets as well as make retail purchases.

### BACKGROUND OF INVENTION

The present invention relates to the field of monetary transactions involving lotteries, gaming, and wagering utilizing mobile devices.

Lottery, wagering and gaming transactions initiated through wireless or Internet-based mechanisms are currently required to use a credit or debit facility managed by a third party; or the operator of such games must maintain a centralized value account for each participant. In many jurisdictions, the use of a credit card account is illegal. The use of third party or sponsor managed debit accounts has proven cumbersome, expensive, and unpopular.

In the known mobile environments, subscribers typically use their Mobile Appliance (MA) for such activities as placing a person-to-person call, sending a text message, transferring still pictures, browsing the web or checking their bank balances against known accounts. With the increasing usage of mobile phones that utilize a Miniature Smart Card (MSC) comes the advent of even more functionality to include electronic payment.

Current methods of electronic payment require credit accounts. U.S. Pat. No. 6,416,414 describes a gaming system that allows a number of mobile customers to participate in a game with a central play station through the mobile network. This patent mentions that the Subscriber Identity Module (SIM) card can store a prepaid cash amount that could be used to pay for wagers and then to book any winnings, but does not disclose how this is accomplished.

International patent publication no. WO03/100736 A1 describes a transmission unit that uses the GSM infrastructure to add additional credit to SIM cards through the GSM Network, however, this mechanism requires the use of the GSM infrastructure and the credit relates to that given by the operational center of the mobile telephony.

International patent publication no. WO 97/28636 makes it possible for a player to use a push button telephone to take part in gambling procedures via the telecom network. After entering a PIN number and a bank account number, the participant could select and then participate in that game. This is a system that depends on a bank account which is debited. As previously described, this method has proven to be cumbersome, expensive, and unpopular.

U.S. Pat. No. 6,021,944 discloses a double ended transaction terminal (which has a clerk operated Man-Machine Interface (MMI) on one side, a customer MMI on the other, and a smart card reader in the middle). This device supports an externally inserted ISO7816 compliant smart card, but does not disclose a wireless interface.

### SUMMARY OF INVENTION

The invention is directed to a method for purchasing an opportunity in a game of chance, comprising: giving, by a subscriber, an amount of money to a retailer who is an authorized agent for the game of chance; receiving, by a retail charging terminal, the money in either hard currency or electronic form; transferring electronically the amount of money from the retail charging terminal to a mobile appliance of the subscriber; and using the mobile appliance by the subscriber to purchase the opportunity in the game of chance.

The invention is also directed to a mobile appliance used for purchasing an opportunity in a game of chance, comprising: a long-range wireless communication system; a short-range communication system; a cash transaction storage device that is loaded with e-cash using the short-range communication system; and software used to play the game of chance that utilizes the long-range wireless communication system.

The invention is also directed to a mobile appliance used for purchasing a product or service, comprising: a long-range wireless communication system; a short-range communication system; a cash transaction storage device that is loaded with e-cash using the short-range communication system; and an access mechanism configured to purchase the product or service.

A retail charging terminal for transferring e-cash to a mobile appliance, comprising: a first interface configured to get a cash value at game of chance retail establishment from an authorized agent; a second interface configured to transfer cash value to mobile appliance of a subscriber over a short-range communications channel; and hardware and software coupling the first interface and the second interface.

Finally, the invention is directed to a system for obtaining e-cash for playing games of chance or making retail purchases, comprising: a mobile appliance comprising a mechanism for playing games of chance or making retail purchases over a long-range wireless communications network and for obtaining e-cash over a short-range communications network, the mobile appliance comprising a subscriber information module configured to hold and transfer the e-cash; and a retail charging terminal configured to be loaded with cash value by a retailer who is an authorized agent of a service, the retail charging terminal comprising a short-range communications network configured to communicate with the short-range communications network of the mobile appliance and to transfer the e-cash to the mobile appliance over the short-range communications.

### DESCRIPTION OF DRAWINGS

The invention will now be described, by way of example according to various embodiments of the invention, with reference to the appended drawings, of which:

FIG. 1 is a pictorial schematic diagram illustrating the RCT, MA and SIM card;

FIG. 2 is a flowchart describing the process for initiating a secure communication session;

FIG. 3 is a flowchart describing the process for loading money onto the SIM card;

FIG. 4A is a block diagram of the RCT;

FIG. 4B is a block diagram of the MA;

FIG. 5 is a block diagram illustrating the overall gaming system;

FIG. 6 is a combination block/communication sequence flow illustrating the sequencing of transactions for downloading the money into the SIM of the MA;

FIG. 7 is a diagram illustrating an exemplary series of screen shots used to make a lottery ticket purchase;

FIG. 8 is a diagram illustrating an exemplary series of screen shots used to perform a retail transaction;

FIG. 9 is a block diagram illustrating an exemplary file management structure for the SIM card; and

FIG. 10 is a block diagram illustrating an exemplary hardware structure for the SIM card.

### DETAILED DESCRIPTION OF THE PREFERRED EMBODIMENTS

An embodiment of the invention described below provides a monetary transaction system and method for a mobile appliance (MA) adapted to lottery, wagering and gaming transactions that bypasses a telephone (e.g., GSM) network, and uses a Retail Charging Terminal (RCT) that is located at an authorized retailer.

This embodiment is intended to create a secured source of stored, prepaid cash value in electronic format (e-cash). Authorized players of lottery, wagering, or gambling games can conveniently carry this secured store of prepaid value in a Mobile Appliance (MA). This permits operators of such games to operate within the limits of the law in many jurisdictions and provide significant improvements in subscriber service and convenience.

Technology has advanced to the level where Mobile Appliances provide convenient and secure access to the Internet. Examples of mobile appliances envisioned within the scope of this invention include, but are not limited to, mobile telephones, personal digital assistant (PDA), pagers, or proprietary devices. The enabling component that permits such mobile devices to act as a repository of secure, stored value is the Miniature Smart Card (MSC), such as a SIM, USIM, RUIM or UICC. These devices are equipped with a Central Processing Unit (CPU), Random Access Memory (RAM), Non Volatile Memory such as FLASH, and an operating system that is used for resource management, file structure, and information exchange with another controller in the Mobile Appliance.

Historically, there has been no way to comprehensively securely reload the operating system, modify the file structure and add e-cash to a SIM card in a MA using short-range communications for the purpose of lottery, wagering, gaming or retail purchases. This invention utilizes an a RCT apparatus as a way of adding e-cash to a SIM card in the mobile appliance. Using the MSC as a repository of prepaid, secured, stored value in an MA and charging it wirelessly at an authorized retailer has never before been used to support lottery, wagering, and gaming or other retail applications. By introducing this new payment system, the inventors provide a system and method for convenient electronic cash transactions for playing lottery, wagering, or gambling games and for the payment of winnings, in the form or e-cash, which adds flexibility to the mobile generation.

In an embodiment of the invention, initially the RCT will communicate with the mobile appliance via, e.g., a short-range secured Bluetooth® air modem interface. The number of potential applications is bound only by the imagination of the developer, and this embodiment provides for only a few examples of the possibilities that this invention will enable. From a historical perspective the SIM can be thought of as an MSC that was designed to provide a secured, tamper resistant environment for the storage of cryptographic keys, subscriber information and phone books that can be moved from one mobile appliance to another. The SIM provides flexibility and portability to the subscriber. The description below may use the terms MSC and SIM interchangeably, despite the distinction described above-however, use of one term or the other should not be construed as limiting in any manner.

The RCT apparatus has the ability to securely load money and record the transaction in the retailer's environment and concurrently on the SIM Card. The retailer has the ability to reward their subscribers with any type of loyalty scheme that they see fit, such as discounts across n number of purchases, or perhaps a free lottery ticket. Once the prepaid value has been put on the card, the subscriber will have the ability to download lottery templates and purchase lottery tickets wirelessly with their MA. It is desirable that the e-cash transaction is secured, and all transactions that occur with that cash are summarily secured, to ensure that the event cannot be replayed as an attempt to access or steal the e-cash from the SIM. All data (such as cash and loyalty points awarded and stored on the card) are ideally encrypted, with the most cost effective method (e.g., RSA, 3DES, etc.), although some balance between efficiency and security must be reached as any encryption event can consume a considerable amount of time and memory.

The file structure on the SIM can be configured to support multiple applications and multiple purses and all of the lottery transactions can be stored and recorded for some predefined time. The subscriber may then have the ability though the Wireless Internet Gateway (WIG) to download and select their lottery tickets from a lottery server, place a bet, or make a purchase from that retailer.

The SIM card has a finite amount of space in which to load applications such as a purse and or lottery card templates, and thus some care is taken to efficiently store applications and their respective data on the SIM. In embodiments of the invention, the Subscriber will not only have the ability to download their tickets, but also: 1) to use their favorite numbers, 2) check to see if any previous tickets were winners, and, if the local service provider has set up SMS provisioning, 3) to receive notification if they won. The MA can be thought of as a personnel security device or portable terminal that allows the customer to access the bank accounts, phone books, use e-cash to participate in interactive gaming or pay for any other service wirelessly and securely.

The system and method according to an embodiment of the invention permit adding secured electronic cash to a mobile Internet appliance using a Retail Charging Terminal (RCT) provided for such purpose by an operator or retail agent of a lottery, wagering, gaming or retail facility, or its trusted agent; and then being able to subsequently add or subtract e-cash to or from such a mobile Internet appliance possibly utilizing encrypted wireless transactions with the operator's host server.

The RCT may communicate with the mobile appliance by a variety of mechanisms that include, but are not limited to, Bluetooth®, WiFi®, 802.11b, infrared, or USB 1.0 & 2.0 and if need be, connect to the GSM infrastructure through a Base-band Transceiver. Due to the fact that there is a level of interaction between the content provider and the application selected by the subscriber, it may be necessary to allow the transfer of winnings back to a customer's E-Purse. All transactions may be secured using advanced encryption algorithms that may include, but not be limited to SSL, W-PKI, RSA, & CRT.

Embodiments of the invention may also include the creation of java based game templates designed for implementation on the MSC operating system in concert with the standard applications of the mobile appliance. The lottery, wagering, or gaming application embedded in the MSC will require activation by the game operator or it's trusted agent. Activation may include the verification and addition of biographical information and account information associated with the player.

Upon activation, the player may then be permitted to set up play preferences for any game within the established template. Such preferences may include specific game formats, numbers to be consistently played, or other pre-settable aspects of game play. Such game preferences can be established in the Mobile Appliance, and later accessed by the player, using the pre-existing menu system provided by the supplier of the Mobile Appliance (e.g., the player would go to the “Games” section of the menu and then scroll to the specific game to be played, activate pre-selected options, or select a new set of game parameters). Once selected, the game play data could be sent wirelessly to the operator's host server in an encrypted format via the Internet, using standard Short Message Services (SMS). The operator may respond to such play by sending an acknowledgement of the lottery purchase, wager, or bet made to the player. Such acknowledgement could include such elements as control or transaction number, lottery numbers purchased, wagers made, bets placed, and other information required by law or custom. Concurrently, the operator could debit the amount of the transaction from the secure value held on the MSC. The complete acknowledgement would be sent to the player via SMS. In the event the player won a cash prize, such cash value would then be downloaded from the host server to the player's Mobile Appliance in encrypted format.

An aspect of an embodiment of the invention is to provide that the value is transferred from the Retailer, who is an authorized agent of a service other than the Mobile Appliance long-range communications infrastructure service provider, to the Subscriber, and the Retailer provides the value to a retail charging terminal that then transfers the value into the Mobile Appliance in a contemporaneous manner, i.e., that the transaction occurs in a time frame that a normal retail transaction at a store would take place in. Another aspect of an embodiment of the invention provides that this transaction takes place in a proximate manner, i.e., that the transaction occurs in a relatively small area, such as an area that a normal retail transaction at a store would take place in.

The invention serves to extend the capabilities of the SIM card beyond its current definition, and serves to migrate Subscribers closer to a cashless society as described below.

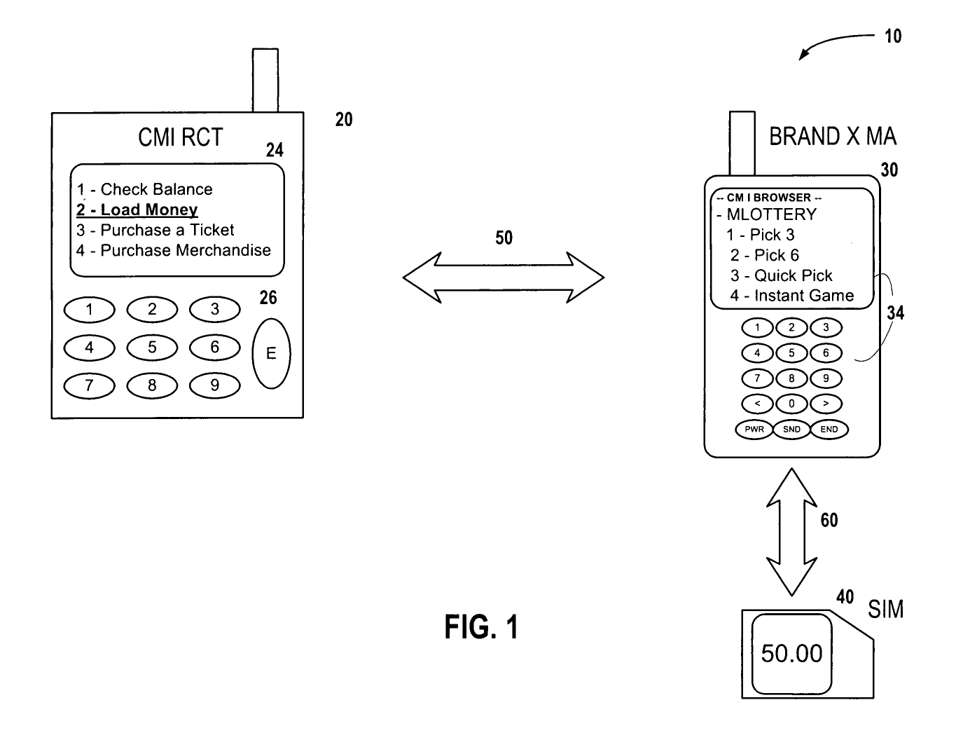

The following description refers to various embodiments of the invention. FIG. 1 is a diagram of the user components for a basic wireless system concept that will allow an authorized retailer, when using a Retail Charging Terminal (RCT) 20, to establish an e-cash session with the Mobile Appliance (MA) 30. The MA 30 is configured to engage in long-range wireless communications, that could include a telephone infrastructure, and to engage in short-range communications, which could be wireless or wire-bound. It should be understood that the discussion below referring to wireless short-range communications are illustrative of an embodiment of the invention and that the invention could comprise a wire-bound short-range communications mechanism known to those skilled in the art, such as using a hard-wired network such as IEEE 802.3, USB, FireWire, RS-232, or the like.

The term short-range wireless communication is to be understood as including variations Bluetooth®, WiFi®, any variant of the IEEE 802.11 specification, infrared, etc. However, these specific implementations are not to be read as limiting the invention in any way. The invention encompasses any wireless communication hardware and or method designed for implementing a local area network (LAN) or personal area network (PAN). This is distinguished from long-range communications that are designed to implement a wide area network (WAN) that may include a telephone network and the like.

Preferably, the transaction between the RCT 20 and the MA 30 is conducted in a secure manner. Handling money and providing a mechanism to carry it around in the form of e-cash infers that additional measures should be taken to ensure that related transactions can occur securely. Known radio frequency (RF) technology permits the present wireless mobile society to utilize wireless communication channels to transfer money, whether it's WiFi®, W-CDMA, GSM, Bluetooth®, CDPD, etc. If communication over these channels are not properly managed and encrypted, it can be intercepted (by any one that might have the means, or might be listening), and then scanned for any meaningful information. Just as a pickpocket has the ability to physically take money out of a wallet, a more advance electronic wireless hack could be used to remove that e-cash (wirelessly and clearly without the legitimate user's knowledge) from a SIM card if the event wasn't secured.

The RCT 20 may serve as the device that initiates the transaction. In this embodiment, the RCT 20 establishes the secure exchange 50 between the RCT 20 and the MA 30, and eventually loads money into the MSC (which may be a SIM) 40 on the MA 30. The MA 30 responds to the request by sending a secure key, which is sent back to the RCT 20. The keys are matched and hashed, thereby establishing a secure session. When a session key is dynamically created for this transaction, a secured transaction handshake occurs between the RCT 20 and the MA 30. This handshake really involves three specific: the RCT 20, the MA 30, and the MSC 40, that interact as described below.

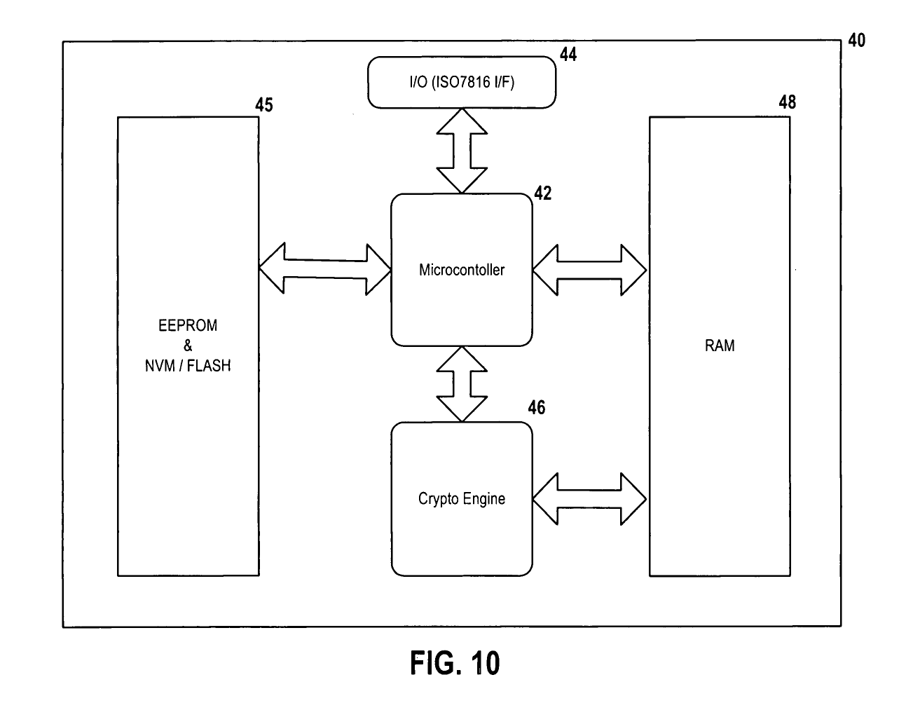

The MSC 40 may be implemented by a SIM card 40, whose exemplary hardware structure can be seen in FIG. 10. Every GSM compatible MA 30, whether a phone, PDA, Tablet PC, etc. includes a SIM card 40. These SIM cards 40 typically carry information about the subscriber, such as its subscriber's address book, phone number, recently dialed numbers, and other value added services which are typically enabled by their service provider. Importantly, the SIM card is a removable portable device that contains the users identity, and it also represents the contract with the user's service or network provider. The card is basically an embedded controller, which comprises a microcontroller 42, an I/O 44, non-volatile memory (e.g., EEPROM, Flash, etc.) 45, volatile memory (RAM) 48, and cryptography engine 46.

The I/O 44 conforms to something commonly referred to as an ISO7816 contacted interface that provide the basic I/O, which utilizes the following power drives and signals: VCC (3.3-5.0 VDC), GND, CLK(Clock), and RST (Reset).

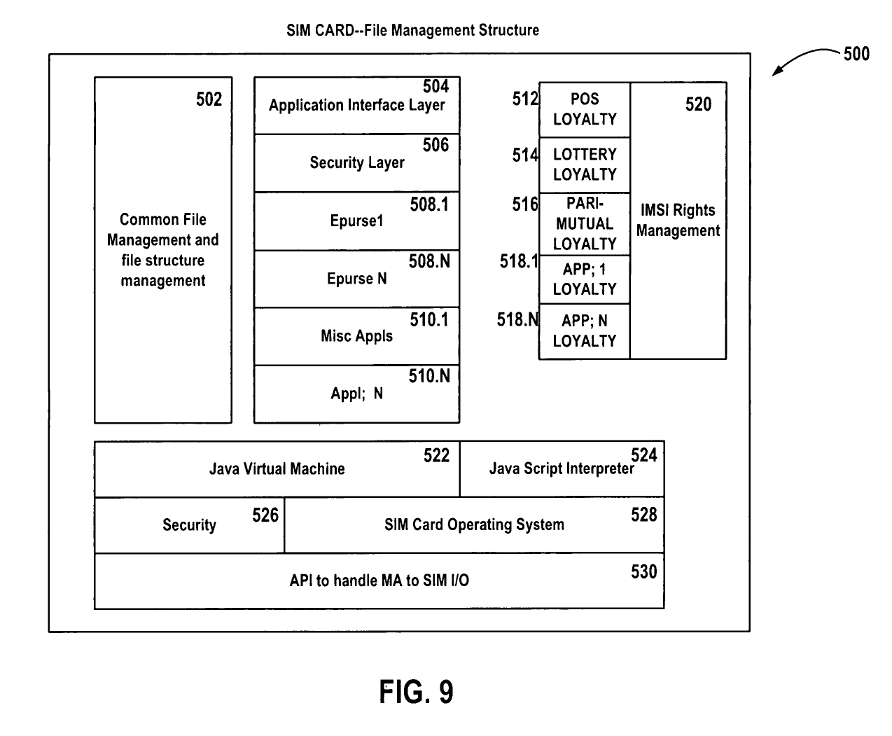

The SIM 40 contains the microcontroller 42 and has an operating system that controls the on board resources, and the file structure 500 (FIG. 9), which allows the card to store the subscriber's demographics, account information, and any other value added features that they have paid for. In most cases, the microcontroller 42 is unlikely to have enough power to handle cryptographic functions, so the crypto engine 46 acts as a coprocessor; any (DES, 3DES, CRT) encryption request will be sent to the cryptography engine 46 which leaves the microcontroller 42 in charge of all other activities. In most cases, the RAM 48 will be split to support a provision that allows accessibility by both the crypto engine 46 and the microcontroller 42, which means that private cryptographic keys can be stored in a separate area that is accessible only to the SIM 40. The SIM 40 basically has the same inherent computational power that the first-generation PC's had, with the exception of not having a man-machine interface (the MA 30 provides the man-machine interface for the SIM 40).

Initiate Secure Communication Session Between the MA and RCT

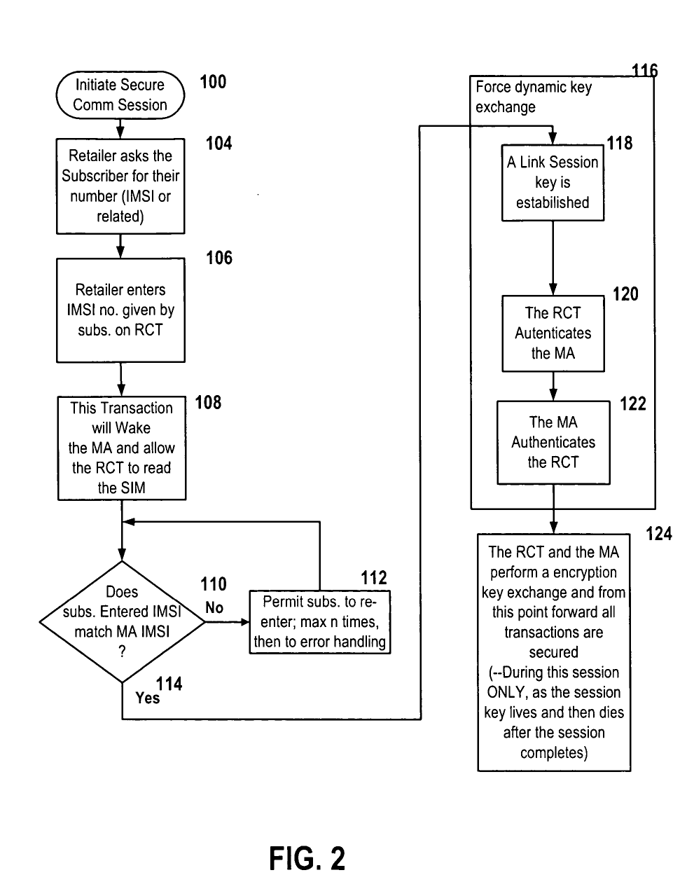

FIG. 2 is a flow chart demonstrating an embodiment involving a basic secured pairing and key dynamic key exchange concept to ensure that the RCT 20 can establish a communications link and allow the secured transaction 50 to take place. A Subscriber of one or more services, that includes at least a telecommunications service, such as GSM, GPRS, or some other common 2.5G, 3G or 4G service, who wishes to have e-cash downloaded to his MA 30 first indicates this interest to a retailer who is an authorized agent associated with an entity for which the e-cash request relates (e.g., an authorized agent for a state lottery). The first step 100 is to ensure secure communications between the RCT 20 and the MA 30 (the RCT 20 being located on the premises of the Retailer). The Retailer at 104 first asks the Subscriber for the Subscriber's number uniquely identifying the Subscriber's MA 30 device. Usually, this number is the IMSI number (or one that is related, preferably with a one-to-one correspondence), and known only to the Subscriber, who was provided this number when the mobile device was activated. In theory, the telephone number itself could be used, but this would not be the case in an embodiment in which it is desirable to eliminate use of the telephone infrastructure for short-range communications. The use of the IMSI number permits the Subscriber's MA 30 to be positively identified to the Retailer and respective RCT 20.

The Retailer at 106 then enters this IMSI number given by the Subscriber on the RCT 20. This could be performed by the retailer interacting with a user interface of the RCT 20, and possibly by pressing an “INIT” key. This action causes the RCT 20 to attempt to establish a low-level communications link up with the MA 30. In an embodiment of the invention, the RCT 20 attempts to establish a Bluetooth® (or equivalent short distance communication mechanism) link with the Subscriber's MA 30 through its communications port and wirelessly connect to the MA 30. It is possible to use a physical connection based variant in which the MA 30 connects to the RCT 20 via a cable, cradle or other configuration.

In the above embodiment, the MA 30 at 108 wakes up in that it views the RCT 20 inbound communication request as an interrupt needing service by the MA 30. The subscriber's number is part of the communications payload needed to build the communications session and then positively identify itself to the RCT 20. The retailer is not required to interact with the RCT 20 (during this time frame) due to the fact that the devices are attempting to open up a communications channel. This interaction may be done in software. The RCT 20 sends a command to read the IMSI data on the MA's SIM card 40, permitting the RCT 20 to have access to the SIM card 40.

The SIM IMSI is read and compared at 110 against the Retailer entered (and customer supplied) IMSI, or related, number. If these numbers do not match, then the Subscriber/Retailer are given some number n of tries to re-enter the IMSI number 112. If this maximum number n of tries is exceeded, then some form of error handling, possibly including informing the Subscriber to contact the Subscriber's MA service provider to obtain the correct IMSI number. If there is an IMSI match at 114, then low level communications have been established, and a dynamic key exchange 116 (paring requirement) is forced. First, a link session key is established at 118, the RCT 20 authenticates the MA 30 (at 120), and the MA 30, in turn, authenticates the RCT 20 (at 122). The key paring mechanism comprises a public key and a private key for each of the RCT 20 and MA 30, and is operated in accordance with known cryptographic algorithms for public-key/private-key communications. Once this key exchange 116 has taken place, the remaining transactions between the RCT 20 and the MA 30 are secure because the communication data is encrypted with the keys known only to the RCT 20 and MA 30 during that session—note that the session key is valid only for a particular session 124.

### Embodiment 1

### Load Money into SIM Card

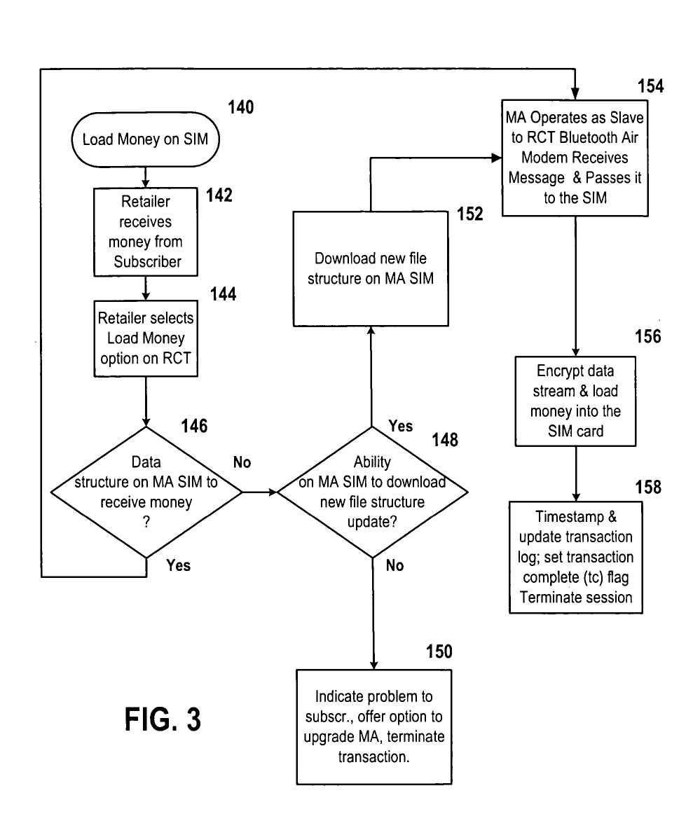

Once the secure session has been established, the next task might be to actually load money onto the SIM card 40 from the RCT 20 via the MA 30. FIG. 3 is a flow chart that illustrates a basic load operation 140 in which money is loaded into the SIM card 40. According to an embodiment of the invention, this event occurs at an authorized retail site using the RCT 20. Advantageously, as noted above, the RCT 20 has the ability to establish a short-range communications with the MA 30 using, in an embodiment, a wireless secure Bluetooth® session that doesn't depend on the cellular telephone infrastructure. This short-range wireless interchange has the advantage of increasing reliability, since problems that affect long-range communications are not a concern, and additional costs associated with access through the long-range communications system or telephone infrastructure can be avoided. Both the RCT 20 and the MA 30 have the ability to initiate and manage a secure transfer of e-cash.

According to FIG. 3, once the secure connection has been established (FIG. 2), the Subscriber then hands the money that should be loaded to the SIM card 40 to the Retailer 142. The retailer selects, e.g., a load money option on an RCT 20 user interface 144. The RCT 20 or MA 30 may check to see if an appropriate memory structure is available on the SIM card 40 to permit loading of the e-cash 146. It is anticipated that the MA 30 of the Subscriber has the latest e-cash compliant setup, but if it does not, a determination is made to see if the MA 30 has the capability of downloading a new structure to the SIM 40 148. If the new structure required for the e-cash download cannot be updated onto the SIM 40, then this problem is noted to the Subscriber and the Subscriber may be provided with, e.g., a termination message indicating how he or she can upgrade the MA 30 (150).

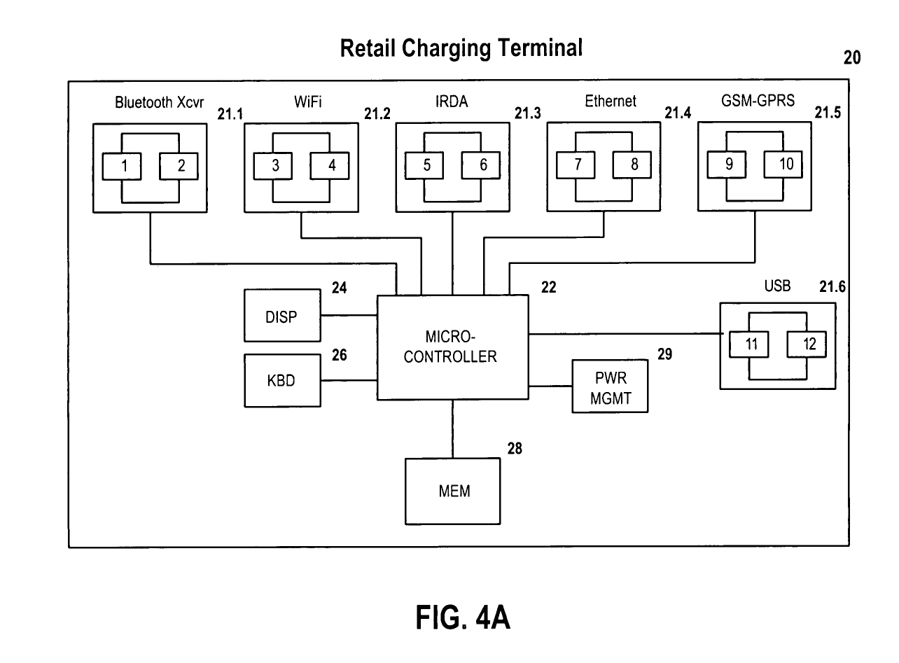

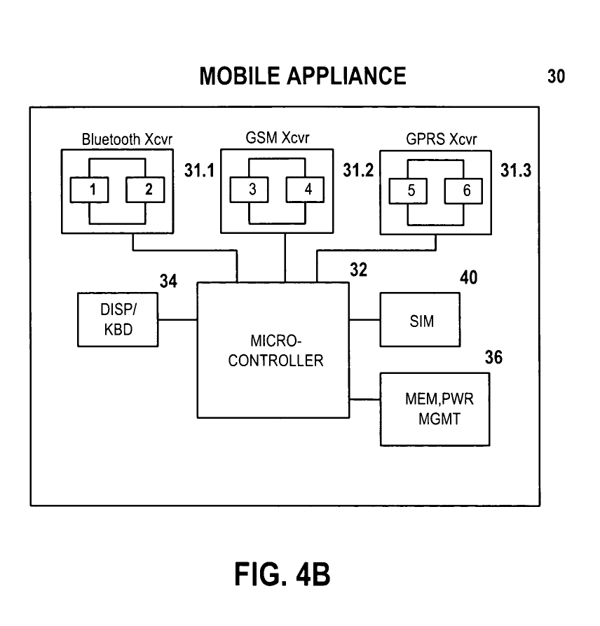

If the MA 30 can download the new file structure 500 (FIG. 9) to accommodate the e-cash, it then does so 154. According to this embodiment, the MA then operates as a slave to the RCT Bluetooth® air modem, receiving messages and passing relevant ones to the SIM 152. The data associated with loading money is transmitted over the secure data stream and the money is loaded into the SIM card 156. It is generally desirable to timestamp the transaction and update some sort of log file, then terminate the session 158. It may be possible to also reverse the master-client relationship between the MA 30 and the RCT 20. The file structure 500 may support multiple purses 508.1-N (FIG. 9), and so the e-cash is loaded into the appropriate purse. In this scenario, the MA 30 operates as a slave to the RCT Bluetooth® modem 21.1 (FIG. 4A) which receives the communicated messages and passes them along to the SIM 40.

When the transaction completes, the Subscriber may be notified via some communication mechanism that he has money and can check his balance to insure that the transaction has updated his purse; the Retailer may also be able to check and see that the transaction completed. The Subscriber now has e-cash on his MA 30, which can be used for any number of cash related transactions, such as in the following events: Lottery, Wagering, Gaming, and/or Retail Purchase.

In more detail, and referencing FIG. 4A, once the secure session has been established, an e-cash load request 140 may then be routed through, e.g., a Bluetooth® port 21.1 of the RCT 20 and a Bluetooth® port 31.1 (FIG. 4B) of the MA 30. The MA 30 can then in turn talk to the microcontroller 42 in the MSC 40 and determine if a file structure 500 presently on the MSC 40 is configured to handle the e-cash storage request. If it can, it will update the purse as requested. If it cannot, then the RCT 20 will need to copy a new file structure 500 into the MSC/SIM 40 that can handle the purchase.

The MA 30 has it's own controller 32 and as such it is responsible for controlling it own I/O for communication elements such as IRDA, GSM, GPRS and Bluetooth ports. In a typical application, the MA 30 is either connected to the GSM infrastructure all of the time or it operates in an idle mode. Thus, when an attempt is made to load money into the SIM card 40, the RCT 20 will attempt to establish, e.g., the secured Bluetooth communication session 50. This event creates a distinct connection between three specific controllers (RCT 20, MA 30 and SIM 40), and a wireless link between the two devices (RCT 20 and MA 30). A controller 22 on the RCT 20 passes the initial session link request through it's onboard Bluetooth transceiver 21.1, to a recipient MA's Bluetooth transceiver 31.1. This event will take the device out of idle mode, simply due to the fact that the MA 30 needs to handle the service request, and that microcontroller 32 in turn will pass the request onto the microcontroller 42 on the SIM card 40.

The SIM card microcontroller 42 and its respective operating system determine how best to handle the e-cash storage request. (Note that the RCT 20, the MA 30 and the SIM card 40 all have their own controllers and software to control the functionality of the respective devices.) After the Bluetooth® link request comes in and the MA 30 determines that the request is to load money on the SIM card 40, a bus connection between the MA controller 32 and the SIM controller 42 is established. A secure wireless session between the SIM card 40, the MA 30, and the RCT 20 is attempted, and if the communication session and a secured session can occur, the MA/SIM system needs to only verify that the file structure 500 in the SIM card 40 can handle the notion of storing money, and, if it can, the money transfer takes place and the transaction completes.

An exemplary file management structure (FMS) 500 for the SIM/MSC card 40 comprising an adaptable plurality of different sub blocks that build on each other can be seen in FIG. 9, which, in this exemplary embodiment, portrays how the environment supports the notion of a field re-loadable multi-application environment. The SIM card 40 generally has standard programmed components or modules that include the SIM Card Operating System 528 (all microcontrollers need some type of operating system to schedule and manage all of the on-chip resources; this OS can support preemptive multitasking.), an applications program interface (API) 530, which is a low-level interface to support libraries that support and enable communications and parameter passing to and from the other sub-blocks, is used to handle communications between the MA 30 and the I/O hardware of the SIM 40, a Security module 526 (the S/N security module controls security encryption requests that travel through the microcontroller 42, and then are offloaded to the cryptography engine 46).

Given the complexity of the encryption task, additional hardware is required in the form of cryptography engine 46, and the associated S/W to manage, dispatch, encrypt, and decrypt), and a Java Virtual Machine (JVM) 522, including Java Script Interpreter 524. The JVM 522 differs from the use of other programming languages in a microprocessor context in the sense that it enables a virtual machine. In most programming languages, the developer must compile the code to support an executable environment, which doesn't provide for much flexibility if the designer would like to expand the scope and functionality of an embedded system. In a JVM, the complier converts the code into something commonly referred to as Java code bytes which are then sent off to the Java Script Interpreter (JSI) 524, which parses and runs the java applets. Other forms of command interpreters could be present as well. A traditional SIM card also includes a portion for IMSI Rights Management 520 and includes some form of Common File Management and File Structure Management 502 for the application layers 504, 506, 508.1-N, 510.1-N that refers to a common file structure needed to ensure that space is effectively managed and that all other applications can peacefully coexist.

The invention also includes additional entities not found on a traditional SIM card 40. In an embodiment of the invention, the SIM card file management structure 500 includes storage and handling associated with various e-purses 508.1-N that may be segregated according to subscribed service, retailer, or other designation. This segregation is used to prevent co-mingling of funds between the various purses that exist on the SIM card 40, and permit independent access and operation with respect to each purse. Access to these e-purses 508.1-N is controlled through the Security Layer 506 as well as the Application Interface Layer 504. Code and data associated with various applications 510.1-N are also provided that can be used for management or can also be related to the applications themselves, such as playing the lottery or other game related (or even retail) activity. Some form of a loyalty mechanism 512, 514, 516, 518.1-N (a mechanism used for providing a customer reward) can be provided, such as discounts across n number of purchases, free lottery tickets, etc.

In instances where a new file structure cannot be downloaded to the MA 30 due to the capabilities of the MA 30, it may be possible to recommend to the subscriber the purchase or lease of an updated device. Local service providers may be contacted to ensure that the subscribers have an MA that, at the very minimum, has a Bluetooth interface, is GSM compatible, and has a SIM module that is large enough to accept over-the-air (OTA) modifications, which would serve to address any potential compatibility issues and at the same time potentially expand the service provider's customer base.

It is important to note that the transferred money is stored in non-volatile memory (NVM), such as flash memory, which is located on the MSC 40. This implies that once the money has been loaded onto the card, it may be moved from one MA 30 to another MA 30, allowing the subscriber a level of flexibility that would permit the subscriber to use either their PDA, cell phone, tablet PC or any other MA 30 that they might have that may support the MSC 40. Any e-cash transaction will be recorded once money has been loaded into the MSC 40. Events such as these must be secured, and from the subscribers and retailers vantage point, these events should appear seamless.

Once the session is established, the retailer has the ability to update multiple e-cash purses residing on the MSC 40 (such as a lottery, loyalty, gaming purse), or replace the Operating System of the MA 30 over the air (OTA), as a secured update session. The loyalty purse is a purse in which a reward in the form of e-cash for a repeat customer can be placed. Once value has been loaded into the MSC 40, the Subscriber can now use their MA 30 to handle electronic transactions.

The SIM 40, is a form of a miniature smart card (MSC 40) that was designed primarily to provide a secured, tamper resistant environment for the storage of cryptographic keys that GSM carriers use to authenticate individual Subscribers to the mobile infrastructure, and track those Subscribers' activities once they are on the air. This card is also used to keep track of the Subscriber's network usage to ensure proper billing, and to also allow the Subscriber to store their phone book. Mobile subscribers may be using a number of different MAs 30; it is desirable to reduce the amount of complexity. One way to reduce the complexity is to integrate the features of those other devices into one device, or to provide a tool that might allow such integration to happen.

If cash can be stored on the MSC 40, the Subscriber no longer needs to carry money for a transaction. By giving the Retailer the ability to load cash into a device that can be carried in a shirt pocket, a secured electronic wallet is created that can be loaded by a retailer or an authorized agent of a particular merchant. This electronic wallet will allow the customer to download, via, e.g., Short Messaging Services (SMS), items such as lottery tickets, the ability to participate in an interactive game of chance, to make a retail purchase, or to download other applications that could expand the capabilities of the MA 30. This process can be viewed as an innovative way to increase the (non-telecommunications) service providers revenue stream, and provide a way to support a cashless transaction, and better service the needs of the subscriber base.

The FIG. 4A block diagram of an exemplary RCT 20 shows the generic embedded microcontroller 22 running an operating system that manages the on board resources, such as: a memory 28 (e.g., flash memory and SRAM), a keyboard (or other input mechanism) 26 (by scanning and encoding user input), and a display 24 (by e.g., updating a screen). The I/O ports 21 are commonly referred to as modem ports that are currently used to handle any communications payload during a typical communications session. The various I/O ports 21.1-21.6 can be better thought of as the physical hardware or modem transceivers that are used primarily to handle Bluetooth®, WiFi®, IRDA, W-CDMA or GSM, USB, or other similar types of communications sessions. The hardware depends on an operating system that controls the environment and manages all of the hardware resources, partitions memory, and controls the data traffic into and out of the device, interrupt processing, and security and key encryption.

As shown in the block diagram of FIG. 4B of the MA 30 that comprises, e.g., the Bluetooth® transceiver 31.1 (as well as a GSM Transceiver 31.2 and a GPRS Transceiver 31.3) which are tied to the microcontroller 32. The MA 30, just like the RCT 20, has the microcontroller 32 running an operating system that manages the handling of a Bluetooth® communication request. The micro-controller 32 establishes the session, and handles the inter-processor communications needed to transfer e-cash to the SIM 40, and complete the session.

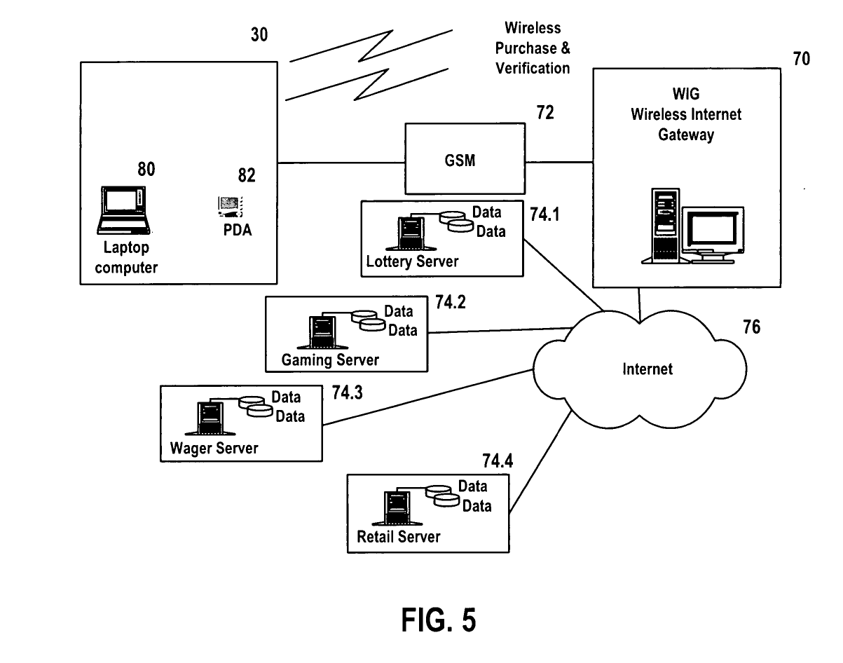

FIG. 5 is a high level diagram that depicts the concept of a Wireless Purchase and Verification System, and, when coupled to the content provider sites, such as lottery, gaming, wagering, & retail sites, completely demonstrates a closed loop, yet interactive process. Once e-cash has been securely transferred into the SIM card 40 that resides inside the MA 30 of the Subscriber, the Subscriber now has total mobility and flexibility to complete any cash transaction wirelessly. Once the back office is in place (i.e., the supporting infrastructure for supporting these types of e-cash transactions, such as a lottery server 74.1, a gaming server 74.2, a wager server 74.3 and/or a retail server 74.4), both the transaction and verification can occur seamlessly and painlessly (provided the subscriber has enough e-cash on the SIM 40 to satisfy the transaction). Access from the MA 30, such as a laptop computer 80 or personal data assistant (PDA) 82, to the services 74 may occur via the GSM network 72 to a Wireless Internet Gateway (WIG) 70, then via the Internet 76 accordingly.

Such a scheme reflects the future in cash transaction processing. Instead of a Subscriber carrying hard cash in a wallet, the Subscriber can have the e-cash removed from the Subscriber's MA 30 to settle a particular transaction. Traditionally, the Subscriber would have to stop at a retail outlet to purchase a lottery ticket and potentially wait in long lines (especially since use of a credit card for lottery transactions is prohibited by law in most places). When the drawing occurs he either watches it on TV as it occurs or checks the paper the next day for the results. This traditional method is an open loop process, whereas the process described above is an electronic transaction, and as such, the information that was exchanged (between the Subscriber and the service provider) to purchase the ticket can summarily be used to notify the Subscriber in real time that he has won, via, e.g., Short Messaging Services (SMS).

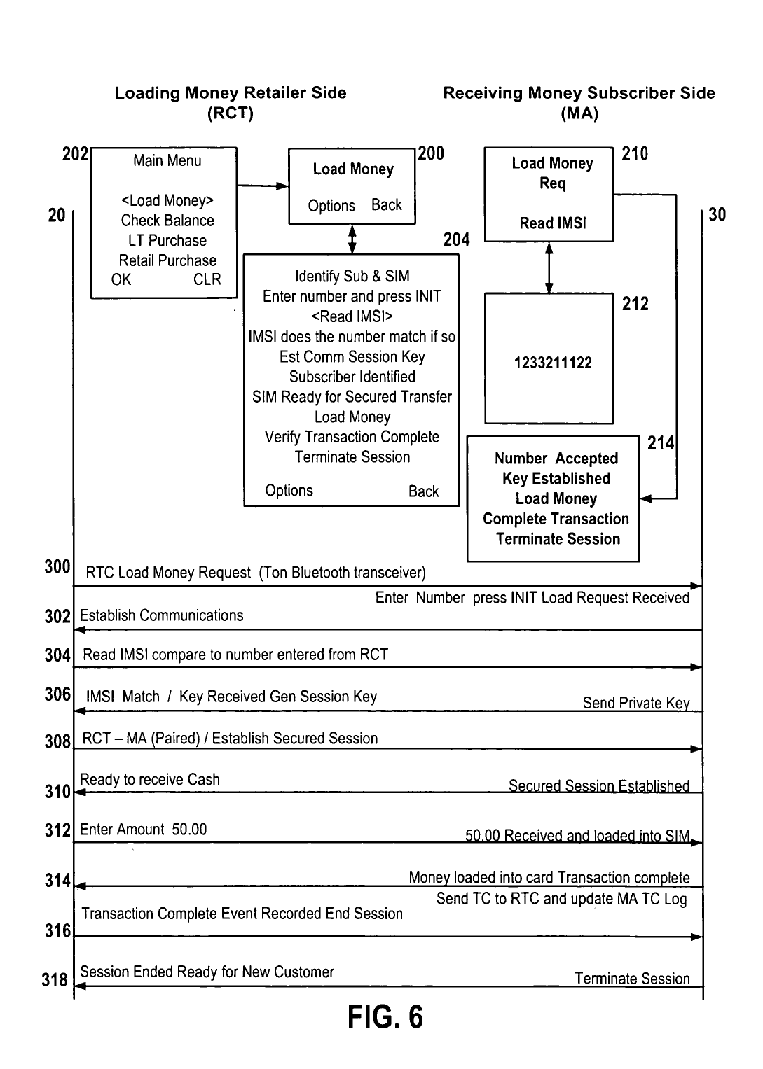

FIG. 6 is a high level block diagram that depicts the communication exchange between the RTC 20 and the MA 30. In the embodiment in which the RCT 20 initiates a secure Bluetooth® session with the MA 30, normally the MA 30 will be running in a standby mode. The RCT 20 may invoke requests by utilizing the user interface components (FIG. 1, display 24 and keyboard 26).

Any outside request, such as a Load Money (LM) request 300 from the RCT 20 (see sample display screen 200, 202, FIG. 6) will generate an interrupt which will force the MA 30 to come out of standby mode and service the request. The Bluetooth® receiver 31.1, e.g., on the MA 30 uses the on board controller 32 to establish communications 302 and talk to the SIM module 40, and determines how best to handle the transfer. In this case, the controller 32 will read the IMSI (MA display 210) to identify the subscriber. If the IMSI cannot be read on the first attempt, the retailer will ask the subscriber to enter their mobile phone number 212, 304. If the entered number is the one that is expected, an initial communications link is established between those to entities 306, and a secured pairing should then occur 308.

Since, in this case, the RCT 20 initiated the event, it will manage the Mutual Authentication and the communications going over the secure session 50. These communications can include file structure change requests, if needed. Once it is determined that the file structure can support an electronic purse, the money will be transferred to the SIM 40. The MA 30 indicates to the RCT 20 that it is ready to receive the cash 310, and the RCT 20 responds by transferring the cash 312; the MA 30 stores this cash on the SIM 40. The MA 30 then responds by sending a transaction complete to the RCT 20, thereby instructing the RCT 20 to update its log 314. The RCT 20 records the transaction and terminates its end of the transaction 316. The MA 30, upon receipt of this communication terminates its end of the session 318. The MA 30 may include a status display 214 to indicate the progress of the transfer. The RCT 20 may include a similar display 204.

### Embodiment 2

### Purchase a Lottery Ticket

There are finite resources on the MA 30, particularly with respect to resident memory as well as an LCD visible display area. Any application running on the MA 30 must utilize these resources sparingly. It is also necessary to make the application easy to work with, otherwise the Subscriber simply will not use it.

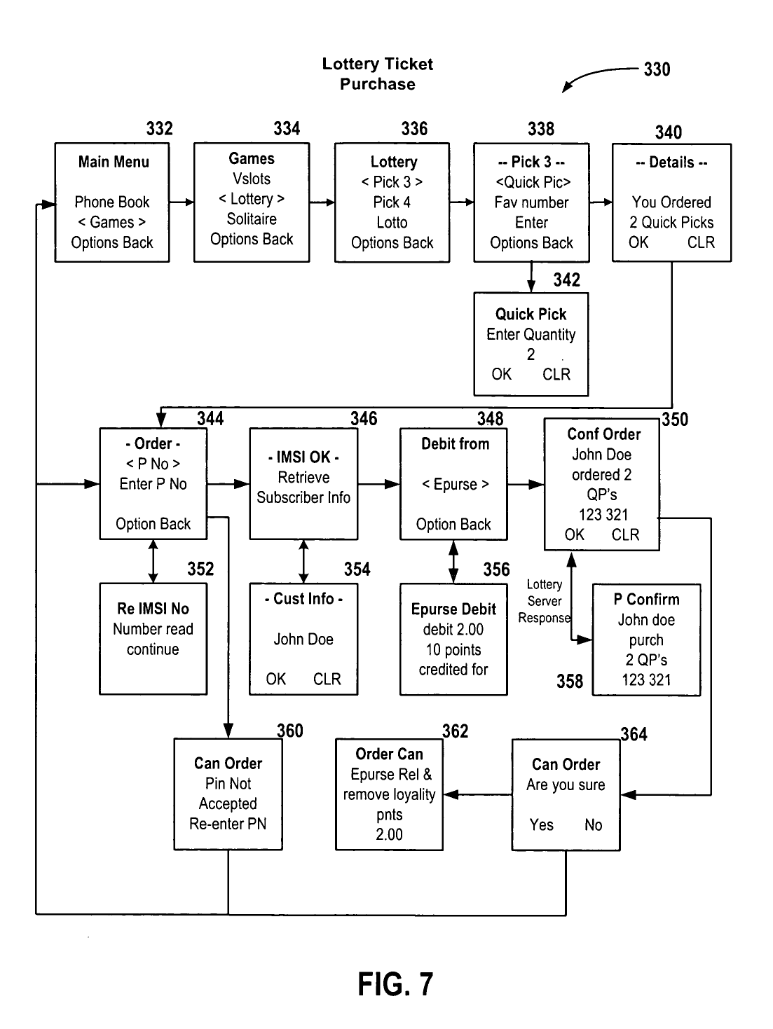

FIG. 7 is a block diagram that steps through exemplary basic screens that would be seen by the Subscriber as the Subscriber makes a lottery ticket purchase 330. This scenario presumes that the Subscriber has previously stopped at their authorized retailer to have e-cash loaded into the SIM card 40 of the MA 30.

From the main menu 332, shown on the display 34 of the MA 30, the Subscriber selects <Games> which takes the Subscriber to the selection screen 334. In this case, the Subscriber <Lottery> which takes them to the choice screen 336, and from that selection screen 336, the Subscriber can pick the game to be played. In this case, the Subscriber has chosen <Pick 3>. This request then triggers a download of a pick 3 lottery card template 338. Templates are generally not stored due the fact that they take up too much memory and also because they have a tendency to be changed. The MA 30 requests the card from the Lottery Server 74.1 and the card will pop up on the display 34. As the Subscriber continues, predefined fields will be filled in with the respective numbers that they select. The display may then provide an option to manually enter a choice of numbers, to select favorite numbers, or use “quick pick” numbers 338, 340, 342.

The Details Screen 340 will reflect the quantity of tickets, numbers chosen, and amount to be debited for this transaction. At this point the GSM Lottery Server 74.1 (FIG. 5) becomes actively involved in the transaction. If satisfied with the number selection, an appropriate amount will be debited from the e-purse, and that money electronically transferred to the Lottery Server 74.1. The order is placed, possibly using a pin number or other verification mechanism, and the International Mobile Subscriber Identifier (IMSI) and/or phone number is checked 344. A confirmation of a validly read IMSI number may be provided 352. If there is an error condition, an opportunity may be provided to re-enter relevant information or to begin the procedure again 360. Upon successful verification 346, various Subscriber information may be retrieved 354, an option to debit the appropriate e-purse is presented 348, and the appropriate amount of e-cash is removed 356 from the SIM card 40.

Next the Lottery Server 74.1 confirms 350 that the Subscriber has purchased a particular number of tickets with the particular chosen or generated numbers for a game to be played at some later date 358. The procedure is similar to a live retail purchase with the exception of providing a paperless and a closed loop system in which Subscribers can purchase lottery tickets at their leisure, and by using their MA 30. In the event that the Subscriber is interested in canceling the order, then a cancellation procedure 364 may be invoked with confirmation that the order has been cancelled 362. Advantageously, the use of e-cash stored on the SIM card 40 does not violate many of the state laws prohibiting credit card transactions for lottery, gaming, or gambling purposes.

### Embodiment 3

### Gaming

The invention envelops other forms of activities besides the Lottery. For example, an embodiment may encompass a gaming application that connects to the gaming server 74.2, such as a virtual slot machine application. The embodiment permits a Subscriber to download a game such as Virtual Slots to the MA 30 (the Subscriber might be charged for the download). As the game is played, any and all winnings are credited to the Subscriber. During play, each pull could debit a predetermined amount, which is selected by the Subscriber during game play.

According to this embodiment, the game Virtual Slots is downloaded to the MA 30 from the gaming server 74.2. All events occur in pseudo real-time. The game applet 510.1 is downloaded to the SIM card 40, and runs on top of a Java Virtual Machine (JVM) 522 environment on the MA 30 (i.e., the game is no longer talking to the server 74.2). The only time that the game applet 510.1 needs to access the server 74.2 is to record and request a win payout, or to request a different game.

Once downloaded, the game can be played off line or in a demo mode to provide the Subscriber a feel for the game play; winnings cannot be claimed unless the game is on line and tied into the infrastructure. The content provider may charge for the value added service (VAS) of the download and the mobile airtime. The server can award winnings in various ways. For example, e-cash can be uploaded to the card (some predefined limits may possibly be utilized), or winnings could be mailed to the Subscriber's residence, and the win event captured in a play log. Other gaming environments are also envisioned, including, but not limited to: interactive Blackjack, Poker, Keno, Bingo, Dice, Pinball, or even PacMan.

### Embodiment 4

### Wagering

In a wagering embodiment, once the Subscriber has loaded money onto their SIM card 40, the subscriber has the ability to participate in events held at tracks in the Subscriber's jurisdiction, such as a horse, or dog racing. The Subscriber may determine what the Subscriber is betting on by making a selection, such as the track, a specific race, the horse, and the type of bet and the amount being wagered. The selection will obviously depend on the odds offered, a range of odds will be made available to the subscriber before making a decision.

As in traditional forms of wagering, the Subscriber can place bets right up to the time the race starts, although factors such as latency and turn around time must be considered. Since this transaction is wireless, the Subscriber needs to be able to place a bet and have the bet recorded on the Wager Server 74.3 and then get an acknowledgement back from the server 74.3 that the bet is now valid. As many other people may be trying to attempt to place bets at the same time, one could run the risk of an all circuits busy scenario, and miss the race altogether. Thus, Subscribers should be encouraged to not wait until the last minute before placing their bets.

If the Subscriber picks a winner, the Server 74.3 may inform the Subscriber, e.g., via SMS that the Subscriber has won and provide, e.g., 3 options for payout:
If the win doesn't exceed a predefined limit, the money could be down-loaded to the purse on the Subscriber's SIM card 40, or a check of the winnings could be mailed to the Subscriber;
If the money exceeds a predetermined limit, a check of the winnings could be mailed to the Subscriber;
If the Subscriber is classified as a “high roller”, the winnings could be deposited to the Subscriber's account, and the Subscriber could be notified via SMS that the winnings for a certain event were deposited. This notification could be provided on the Subscriber's monthly statement.

If the Subscriber does not win, then the Subscriber could check the results with the Wireless Internet Browser (WIB) on the MA 30 and determine, e.g., where the horse placed. If the race is recalled, the Subscriber could automatically be informed via SMS that another horse is now the winner. The Subscriber could be informed of any other types of messages related to the event. Bets for many other types of events are possible, including, e.g., sportsbook—NFL, NBA, NCAA, College Football, NHL, PGA, and Boxing.

Common types of bets used in horse racing are described below. In parimutuel wagering, the track has no interest in which horses win or lose, but acts only as an agent. It only holds the money wagered until the finish of the race and pays the winning ticket holders the proper amount called for by the amount of the tickets. The types of bets include: 1) Win—This is the simplest and most common bet. The Subscriber's horse must finish first; 2) Place—A wager for place means the Subscriber collects if the chosen horse finishes either first or second; 3) Show—A wager for show means the Subscriber collects if the chosen horse finishes first, second, or third; 4) Future—This is a bet on a future event. At the start of each season, the sportsbooks give out odds for horses to win a certain event. The odds change as the race date approaches and in most cases get shorter, but if the Subscriber wins on an earlier placed bet, the Subscriber gets paid at the original odds that the Subscriber took. The mechanisms used for payout could be similar to those described above.

### Embodiment 5

### Retail Purchase

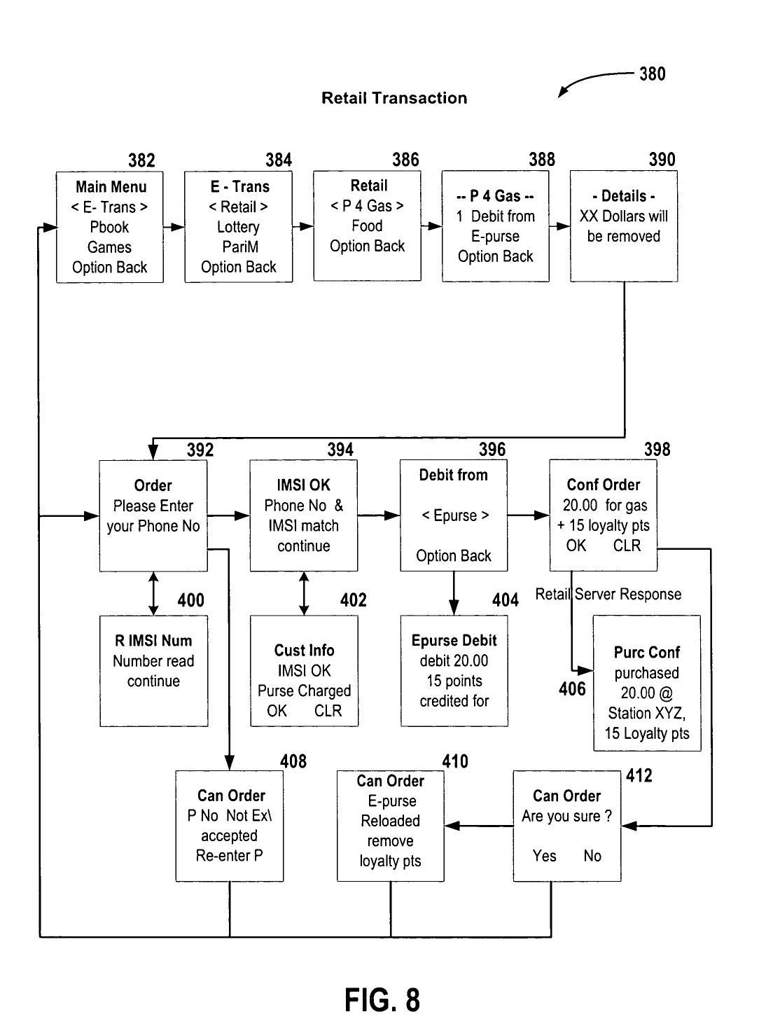

FIG. 8 is a block diagram that illustrates exemplary steps through basic screens seen by a Subscribers as they make a retail purchase 380. In this embodiment, a Subscriber wishes to make a secure purchase with the MA 30. Similar to the lottery ticket purchase 330 scenario, this scenario also presumes that the Subscriber has previously stopped at an authorized retailer to have e-cash loaded into the SIM card 40 of the MA 30. The Subscriber stops by an authorized retailer and would like to purchase some coffee, pay for the gas that the Subscriber just pumped and a donut. The Subscriber would let the retailer know that the Subscriber would like to use e-cash to pay for the sales transaction. In an embodiment of the invention, a Subscriber selects an electronic cash transaction from the main menu 382 and indicates that the transaction is a retail transaction 384, particularly, one of paying for gas 386.

The Subscriber may be presented with an option of debiting the payment from the e-purse or utilizing a credit card or some other form of debit instrument 388. The retailer may ask the Subscriber to enter an approval code on the keyboard, which could be something as simple as their mobile cell number. The Subscriber indicates that a certain amount of dollars should be removed from the e-purse 390, and the order is placed, possibly using a pin number or other verification mechanism, and the International Mobile Subscriber Identifier (IMSI) and/or phone number is checked 392, 400. If there is an error condition, an opportunity may be provided to re-enter relevant information or to begin the procedure again 408. Upon successful verification 394, customer information is obtained 402, an option to debit the appropriate e-purse is presented 396, and the appropriate amount of e-cash is removed 404 from the SIM card 40. Next the Retail Server 74.4 confirms 398 that the Subscriber has purchased particular goods or services 398, 406, the transaction log is updated, and, optionally, the Subscriber is provided with a paper receipt the retailer can print one out.

Since this is an electronic transaction, the transaction log will capture any and all events and the Subscriber has the ability to review their log file at anytime (provided that the transaction completed). That log or transaction may also captured in the Retailer's database to provide supporting data for any disputes that may arise. To minimize events that might cause a challenge of this type, the charge could be verified prior to the Subscriber leaving the Retailer, e.g., simply by checking the transaction log against the receipt just issued. However, the transaction log is only updated by some type of activity such as a purchase, and cannot be changed by the Subscriber and or the Retailer—it is only a record of the transaction. Just as in any retail environment, that Retailer may have the ability to determine any type of loyalty schemes needed to reward their customers for their continued patronage. The event should be seamless. The customer pays for the items and it looked like a cashless transaction. The total is deducted from their SIM card 40, and loyalty sections (512-518.N) are updated.

In the event that the Subscriber is interested in canceling the order, then a cancellation procedure 412 may be invoked with confirmation that the order has been cancelled 410. Again, the procedure is similar to a live retail purchase with the exception of providing a paperless and a closed loop system in which the Subscriber can do at their leisure, and by using their MA 30.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

GLOSSARY

| | |
|---|---|
| 3DES | Triple DES, an encryption configuration in which the DES |
| | algorithm is used three times with three separate keys |
| ARPN | Average Revenue Per User |
| Asymmetric | A Separate but integrated user key-pair, consisting of one public key |
| Keys | and one private key |
| Bluetooth ® | Wireless Communications Environment/Personal Area Network |
| Certificate | An Electronic Document attached to a public key, which provides |
| | proof that the public key belongs to a legitimate owner and has |
| | not been compromised |
| DES | Data Encryption Standard, a 64 bit Cipher, symmetric algorithm |
| | also known as the Data Encryption Algorithm (DEA) by ANSI and |
| | DEA-1 by International Standards Organization |
| Digital Cash | Electronic Money that is stored and transferred through a variety of |
| | complex protocols |
| DRM | Digital Rights Management |
| e-cash | Preloaded Electronic Cash |
| Encryption | The process of disguising a message in such a way to hide it's |
| | substance |
| E-Purse | Electronic Purse, Digital Cash |
| GPRS | General Packet Radio Services |
| GSM | Global System for Mobile Communications |
| HLR | Home Location Register |
| ISO7816 | International Standards Organization Spec, which defines |
| | interface standards that pertain to a contacted card |
| MA | Mobile Appliance |
| MMI | Man Machine Interface |
| MSC | Miniature Smart Card |
| MSC-R/W | Mini Smart Card Reader & Writer |
| Non-Repudiation | Preventing the denial of previous comments or actions |
| OTA | Over The Air |
| PKI | Public Key Infrastructure, a widely available and accessible |
| | certificate system for obtaining the entity's public key with some |
| | degree of certainty that you have the “right” key and that it has |
| | not been revoked |
| R UIM | Removable User Identity Module |
| RSA | Short for RSA Data Security Inc; or referring to the principles: |
| | Rivest, Shamir & Alderman, and it's used in public key |
| | cryptography and is based on the fact that that it is easy to |
| | multiply 2 large prime numbers together, but hard to factor them |
| | out of the product |
| SAT | SIM Application Toolkit |
| SIM | Subscriber Identity Module |
| SMS | Short Messaging Service |
| SMS-C | Short Messaging Service Center |
| SSL | Secured Socket Layer |
| U SIM | Universal Subscriber Identity Module |
| UICC | Universal Integrated Circuit Card // Basically a Multi-application |
| | mini-smart card |
| VPN | Virtual Private Network, allows private networks to span from the |
| | end-user across a public network (Internet) directly to the home |
| | gateway of choice, such as a corporate internet |
| WAP | Wireless Application Protocol |
| WIB | Wireless Internet Browser |
| WIG | Wireless Internet Gateway |
| XML | Extended Markup Language |

1. A method for purchasing an opportunity in a game of chance, comprising:
giving, by a subscriber, an amount of money to a retailer who is an authorized agent for the game of chance;
receiving, by a retail charging terminal, the money in either hard currency or electronic form;
transferring electronically the amount of money from the retail charging terminal to a mobile appliance of the subscriber; and
using the mobile appliance by the subscriber to purchase the opportunity in the game of chance.

2. The method according to claim 1, further comprising:
initiating the transfer of money from the retail charging terminal to the mobile appliance by the retail charging terminal.

3. The method according to claim 2, further comprising:
waking the mobile appliance from a sleep state to a waking state by the initiating of the retail charging terminal

4. The method according to claim 1, further comprising:
providing a subscriber identity module on the mobile appliance; and
transferring the electronic money onto the subscriber identity module.

5. The method according to claim 4, further comprising:
downloading memory structures into the subscriber identity module if they do not already exist.

6. The method according to claim 1, wherein the transferring of the money comprises utilizing short-range communications mechanisms and protocols.

7. The method according to claim 6, wherein the short-range communications mechanisms and protocols are selected from the group consisting of: Bluetooth,® WiFi®, a variant of 802.11, infrared, and USB.

8. The method according to claim 1, further comprising:
downloading games from a game server over a long-range communications network.

9. The method according to claim 1, wherein all method elements except using the electronic cash for purchase take place in a contemporaneous manner.

10. The method according to claim 1, wherein all method elements except using the electronic cash for purchase take place in a geographically proximate manner.

11. A mobile appliance used for purchasing an opportunity in a game of chance, comprising:
a long-range wireless communication system;
a short-range communication system;
a cash transaction storage device that is loaded with e-cash using the short-range communication system; and
software used to play the game of chance that utilizes the long-range wireless communication system.

12. The mobile appliance according to claim 11, further comprising:
a display for outputting information regarding the game of chance to a subscriber; and
an input device for inputting information from a subscriber regarding the game of chance.

13. The mobile appliance according to claim 11, wherein:
the long-range wireless communication system comprises at least one of a GSM, GPRS, 2.5G, 3G and 4G interface scheme or technology; and
the short-range communication system comprises an interface selected from the group consisting of a Bluetooth® interface, a WiFi® interface, a variant of 802.11 interface, an infrared interface, and a USB interface.

14. The mobile appliance according to claim 11, wherein the long-range wireless communication system is configured to give and receive payments of e-cash from and to the cash transaction storage device during play of the game of chance.

15. A mobile appliance used for purchasing a product or service, comprising:
a long-range wireless communication system;
a short-range communication system;
a cash transaction storage device that is loaded with e-cash using the short-range communication system; and
an access mechanism configured to purchase the product or service.

16. The mobile appliance according to claim 15, wherein the access mechanism comprises application software that interacts with a system of a retailer providing the product or service.

17. The mobile appliance according to claim 15, wherein the cash transaction storage device comprises:
multiple purses for storing e-cash from different retailers; and
hardware and software used to manage the multiple purses and prevent co-mingling of e-cash.

18. A retail charging terminal for transferring e-cash to a mobile appliance, comprising:
a first interface configured to get a cash value at a game of chance retail establishment from an authorized agent;
a second interface configured to transfer cash value to a mobile appliance of a subscriber over a short-range communications channel; and
hardware and software coupling the first interface and the second interface.

19. The retail charging terminal according to claim 18, wherein the second interface comprises at least one of a Bluetooth® interface, a WiFi® interface, a variant of 802.11 interface, an infrared interface, and a USB interface.

20. The retail charging terminal according to claim 18, wherein the hardware comprises:
a display configured for providing information about status of an e-cash transfer;
an input device configured for entering information related to an e-cash transfer;
a communications port configured for short-range communications to a mobile appliance;
a microcontroller configured for managing the e-cash transfer and communications over the communications port; and
a memory used to hold information related to an e-cash transfer.

21. A system for obtaining e-cash for playing games of chance or making retail purchases, comprising:
a mobile appliance comprising a mechanism for playing games of chance or making retail purchases over a long-range wireless communications network and for obtaining e-cash over a short-range communications network, the mobile appliance comprising a subscriber information module configured to hold and transfer the e-cash; and
a retail charging terminal configured to be loaded with cash value by a retailer who is an authorized agent of a service, the retail charging terminal comprising a short-range communications network configured to communicate with the short-range communications network of the mobile appliance and transfer the e-cash to the mobile appliance over the short-range communications.
